(19) United States
(12) Patent Application Publication
(10) Pub. No.: US 2020/0140790 A1
(43) Pub. Date: May 7, 2020

(54) CLEANING COMPOSITIONS AND METHODS FOR MAKING AND USING SAME

(71) Applicant: GPCP IP Holdings LLC, Atlanta, GA (US)

(72) Inventors: Andrew Paul Balliet, Appleton, WI (US); Teresa M Redmann, New London, WI (US); Phillip W Hurd, Conyers, GA (US); Lien Hoang Phun, Norcross, GA (US)

(21) Appl. No.: 16/617,713

(22) PCT Filed: May 30, 2018
(86) PCT No.: PCT/US18/34990

§ 371 Date: Nov. 27, 2019

Related U.S. Application Data
(60) Provisional application No. 62/512,423, filed on May 30, 2017.
(60) Provisional application No. 62/520,511, filed on Jun. 15, 2017.

(51) Int. Cl. C11D 10/04; C11D 3/43; C11D 9/02; C11D 3/04; C11D 3/30; C11D 3/20; C11D 3/50; C11D 9/10; C11D 9/30; C11D 9/26; C11D 9/44; C11D 1/66; C11D 17/04

(52) U.S. Cl. CPC C11D 10/045; C11D 3/43; C11D 9/02; C11D 3/044; C11D 3/30; C11D 3/2079; C11D 17/049; C11D 9/10; C11D 9/30; C11D 9/26; C11D 9/442; C11D 1/662; C11D 3/50

(57) ABSTRACT

Cleaning compositions and processes for making and using same. In some examples, the cleaning composition can include about 0.02 wt % to about 26 wt % of a neutralized tall oil fatty acids; about 0.01 wt % to about 9 wt % of a solvent; and about 65 wt % to about 99.97 wt % of water, where all weight percent values are based on a combined weight of the neutralized tall oil fatty acids, the solvent, and the water.

### CROSS-REFERENCE TO RELATED APPLICATIONS

This application claims priority to International Patent Application No. PCT/US/2018034990, filed on May 30, 2018, which claims benefit of U.S. Provisional Patent Application No. 62/520,511, filed on Jun. 15, 2017, and to U.S. Provisional Patent Application No. 62/512,423, filed on May 30, 2017, which are all incorporated by reference herein.

### BACKGROUND

### Field

Embodiments described generally relate to cleaning compositions and methods for making and using same. More particularly, such embodiments relate to cleaning compositions that include one or more neutralized tall oil fatty acids, one or more solvents, and water and methods for making and using same.

### Description of the Related Art

A variety of cleaning compositions are available for users to choose. The particular cleaning composition one may select for a given cleaning task can depend on a variety of factors such as the particular surface to be cleaned and the contaminant desired to be removed from the surface. Stainless steel surfaces are particularly difficult to clean while leaving the surface resistant to fingerprint smudges. Cleaning products have been developed for specifically cleaning stainless steel, but there are typically drawbacks associated with the available cleaning products, e.g., the cleaning products often leave streaks on the surface and/or the cleaned surface tends to attract dust.

There is a need, therefore, for new cleaning compositions and methods for making and using same.

### SUMMARY

Cleaning compositions and methods for making and using same are provided. In some examples, the cleaning composition can include about 0.02 wt % to about 26 wt % of a neutralized tall oil fatty acids; about 0.01 wt % to about 9 wt % of a solvent; and about 65 wt % to about 99.97 wt % of water, where all weight percent values are based on a combined weight of the neutralized tall oil fatty acids, the solvent, and the water.

In some examples, a pre-moistened wipe for cleaning a surface can include a substrate; and a cleaning composition. The cleaning composition can include about 0.02 wt % to about 26 wt % of a neutralized tall oil fatty acids; about 0.01 wt % to about 9 wt % of a solvent; and about 65 wt % to about 99.97 wt % of water, where all weight percent values are based on a combined weight of the neutralized tall oil fatty acids, the solvent, and the water.

In some examples, a process for making a cleaning composition can include reacting a tall oil fatty acids with at least a portion of a neutralizing agent to produce a neutralized tall oil fatty acids and combining the neutralized tall oil fatty acids, a solvent, and water to produce the cleaning composition. The cleaning composition can include about 0.02 wt % to about 26 wt % of the neutralized tall oil fatty acids; about 0.01 wt % to about 9 wt % of the solvent; and about 65 wt % to about 99.97 wt % of water, where all weight percent values are based on a combined weight of the neutralized tall oil fatty acids, the solvent, and the water.

### DETAILED DESCRIPTION

The cleaning composition can be or include one or more neutralized tall oil fatty acids, one or more solvents, and water. The cleaning composition can also include one or more non-ionic surfactants, one or more fragrances, one or more preservatives, one or more corrosion inhibitors, one or more base compounds, one or more chelating agents, or any mixture thereof. It has been surprisingly and unexpectedly discovered that the cleaning composition that includes the neutralized tall oil fatty acids, the solvent, and the water can be used to clean a surface, e.g., stainless steel and/or glass surface, and can leave an oily residue or film on the surface that can be resistant to smudges, e.g., fingerprints, and/or substantially free of any streaking.

The cleaning composition can have a filming value of 1, 2, 3, 4, 5, 6, or 7, as measured according to the Consumer Specialty Products Association (CSPA) DCC-09A (2003) test method. In other examples, the cleaning composition can have a filming value of at least 2, at least 3, at least 4, at least 5, at least 6, or at least 7, as measured according to DCC-09A (2003). The cleaning composition can have a streaking value of 7, 6, 5, 4, 3, 2, or 1, as measured according to DCC-09A (2003). In other examples, the cleaning composition can have a streaking value of 4 or less, 3 or less, 2 or less, or 1, as measured according to DCC-09A (2003). In some examples, the cleaning composition can have a filming value of 1, 2, 3, 4, 5, 6, or 7 and a streaking value of 4 or less, 3 or less, 2 or less, or 1, as measured according to DCC-09A (2003). In other examples, the cleaning composition can have a filming value of 2 or greater and a streaking value of 4 or less, a filming value of 3 or greater and a streaking value of 3 or less, a filming value of 4 or greater and a streaking value of 2 or less, a filming value of 1 or greater and a streaking value of 3 or less, a filming value of 2 or greater and a streaking value of 2 or less, or a filming value of 2 or greater and a streaking value of 2 or less, as measured according to DCC-09A (2003).

In some examples, the cleaning composition can have a viscosity of about 0.5 centipoise (“cP”), about 0.7 cP, about 0.8 cP, about 0.85 cP, about 0.9 cP, or about 0.95 cP to about 1 cP, about 1.05 cP, about 2 cP, about 3 cP, about 5 cP, or about 10 cP at a temperature of about 25° C. The viscosity of the cleaning composition can be determined using a Brookfield Viscometer at a temperature of about 25° C. For example, a Brookfield viscometer, Model DV-II+, with a small sample adapter (e.g., a 10 mL adapter) with, for example, a number 31 spindle, can be used to measure the viscosity of the cleaning composition. In other examples, the viscosity of the cleaning composition can be increased. For example, one or more viscosity modifiers can be mixed, blended, combined, or otherwise added to the cleaning composition to produce a cleaning composition having the consistency of a cream, lotion, gel, paste, or other thickened mixture. Illustrative viscosity modifiers can include, but are not limited to, carbomers, laponites, illites, smectites, micas, or any mixture thereof.

The cleaning composition can have a pH of about 1, about 2, about 3, about 4, or about 5 to about 8, about 9, about 10, about 11, about 12, about 13, or about 14 at a temperature of about 25° C. In some examples, the cleaning composition can be in the form of an emulsion and can have a pH of about 1, about 2, about 3, about 4, or about 5 to about 8, about 9, about 10, about 11, about 12, about 13, or about 14 at a temperature of about 25° C. In other examples, the cleaning composition can be in the form of an aqueous solution and can have a pH of about 6, about 7, about 8, or about 9 to about 10, about 11, about 12, about 13, or about 14 at a temperature of about 25° C. In other examples, the cleaning composition can be in the form of an aqueous solution and can have a pH of about 7 to about 14, about 8 to about 13, about 8.5 to about 12, about 9 to about 11, about 9.5 to about 11.5, or about 10 to about 11 at a temperature of about 25° C.

The cleaning composition can have a solids content of about 0.03 wt %, about 0.1 wt %, about 0.2 wt %, about 0.3 wt %, about 0.5 wt %, about 1 wt %, about 3 wt %, or about 5 wt % to about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, or more. In some examples, the cleaning composition can have a solids content of about 0.03 wt %, about 0.05 wt %, about 0.1 wt %, about 0.3 wt %, about 0.5 wt %, about 0.7 wt %, or about 1 wt % to about 3 wt %, about 5 wt %, about 7 wt %, or about 10 wt %. In other examples, the cleaning composition can have a solids content of about 0.03 wt %, about 0.05 wt %, about 0.1 wt %, about 0.15 wt %, about 0.2 wt %, or about 0.25 wt % to about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, or about 1 wt %. The solids content of the cleaning solution can be measured by determining the weight loss upon heating a sample to a suitable temperature, e.g., 105° C. and for a time sufficient to remove any liquid therein. By measuring the weight of the sample before and after heating, the percent solids in the sample can be directly calculated or otherwise estimated.

In some examples, the cleaning composition can include about 0.02 wt % to about 26 wt % of the neutralized tall oil fatty acids, about 0.01 wt % to about 9 wt % of the solvent, and about 65 wt % to about 99.7 wt % of water, based on a combined weight of the neutralized tall oil fatty acids, the solvent, and the water. In other examples, the cleaning composition can include about 0.02 wt % to about 26 wt % of the neutralized tall oil fatty acids, about 0.01 wt % to about 5 wt % of the solvent, and about 69 wt % to about 99.7 wt % of water, based on a combined weight of the neutralized tall oil fatty acids, the solvent, and the water. In other examples, the cleaning composition can include about 0.05 wt % to about 26 wt % of the neutralized tall oil fatty acids, about 0.05 wt % to about 9 wt % of the solvent, and about 65 wt % to about 99.9 wt % of water, based on a combined weight of the neutralized tall oil fatty acids, the solvent, and the water. In other examples, the cleaning composition can include about 0.05 wt % to about 26 wt % of the neutralized tall oil fatty acids, about 0.05 wt % to about 5 wt % of the solvent, and about 69 wt % to about 99.9 wt % of water, based on a combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, and about 65 wt % to about 99.97 wt % of water, based on a combined weight of the neutralized tall oil fatty acids, the solvent, and the water. In other examples, the cleaning composition can include about 0.02 wt % to about 26 wt % of the neutralized tall oil fatty acids, about 0.01 wt % to about 5 wt % of the solvent, and about 69 wt % to about 99.7 wt % of water, based on a combined weight of the neutralized tall oil fatty acids, the solvent, and the water.

The cleaning composition can include about 0.01 wt %, about 0.03 wt %, about 0.05 wt %, about 0.07 wt %, about 0.1 wt %, about 0.12 wt %, or about 0.15 wt % to about 0.2 wt %, about 0.3 wt %, about 0.4 wt %, about 0.5 wt %, about 1 wt %, about 3 wt %, about 5 wt %, about 7 wt %, about 10 wt %, about 13 wt %, about 15 wt %, about 17 wt %, about 20 wt %, about 23 wt %, about 25 wt %, about 26 wt %, or about 27 wt % of the neutralized tall oil fatty acids, based on a combined weight of the neutralized tall oil fatty acids, the solvent, and the water. The cleaning composition can include about 0.01 wt %, about 0.03 wt %, about 0.05 wt %, about 0.07 wt %, about 0.1 wt %, about 0.12 wt %, or about 0.15 wt % to about 0.2 wt %, about 0.3 wt %, about 0.4 wt %, about 0.5 wt %, about 0.7 wt %, about 1 wt %, about 1.5 wt %, about 1.7 wt %, about 2 wt %, about 2.5 wt %, about 3 wt %, about 3.5 wt %, about 4 wt %, about 4.5 wt %, about 5 wt %, about 6 wt %, about 7 wt %, about 8 wt %, or about 9 wt % of the solvent, based on a combined weight of the neutralized tall oil fatty acids, the solvent, and the water. The cleaning composition can include about 65 wt %, about 67 wt %, about 69 wt %, about 71 wt %, about 73 wt %, about 75 wt %, about 77 wt %, about 80 wt %, about 83 wt %, or about 85 wt % to about 90 wt %, about 92 wt %, about 93 wt %, about 94 wt %, about 95 wt %, about 96 wt %, about 97 wt %, about 98 wt %, about 99 wt %, about 99.3 wt %, about 99.5 wt %, or about 99.7 wt % of water, based on a combined weight of the neutralized tall oil fatty acids, the solvent, and the water.

In some examples, if the cleaning composition includes the non-ionic surfactant, the cleaning composition can include about 0.01 wt %, about 0.05 wt %, about 0.1 wt %, about 0.5 wt %, about 1 wt %, about 2 wt %, about 3 wt %, about 5 wt %, about 7 wt %, or about 10 wt % to about 15 wt %, about 17 wt %, about 20 wt %, about 23 wt %, about 25 wt %, about 27 wt %, about 30 wt %, or about 31 wt %, of the non-ionic surfactant, based on the combined weight of the neutralized tall oil fatty acids, the solvent, and the water. In other examples, if the cleaning composition includes the non-ionic surfactant, the cleaning composition can include about 2 wt %, about 3 wt %, about 4 wt %, about 5 wt %, about 6 wt %, about 7 wt %, about 8 wt %, about 9 wt %, about 10 wt %, or about 12 wt % to about 20 wt %, about 23 wt %, about 25 wt %, about 30 wt %, about 33 wt %, about 35 wt %, about 37 wt %, or about 40 wt %, of the non-ionic surfactant, based on the combined weight of the neutralized tall oil fatty acids, the solvent, and the water.

In some examples, if the cleaning composition includes the fragrance, the cleaning composition can include about 0.001 wt %, about 0.005 wt %, about 0.01 wt %, about 0.05 wt %, about 0.1 wt %, about 0.3 wt %, about 0.5 wt %, about 0.7 wt %, or about 1 wt % to about 1.5 wt %, about 1.7 wt %, about 2 wt %, about 2.3 wt %, about 2.5 wt %, about 2.7 wt %, about 3 wt %, about 3.3 wt %, about 3.5 wt %, about 3.7 wt %, about 4 wt %, about 4.3 wt %, about 4.5 wt %, about 4.7 wt %, about 5 wt %, about 5.3 wt %, or about 5.5 wt % of the fragrance, based on the combined weight of the neutralized tall oil fatty acids, the solvent, and the water. In other examples, if the cleaning composition includes the fragrance, the cleaning composition can include about 0.1 wt %, about 0.3 wt %, about 0.4 wt %, about 0.5 wt %, about 0.6 wt %, about 0.7 wt %, about 0.8 wt %, about 0.9 wt %, or about 1 wt % to about 1.3 wt %, about 1.5 wt %, about 1.7 wt %, about 2 wt %, about 2.3 wt %, or about 2.5 wt % of the fragrance, based on the combined weight of the neutralized tall oil fatty acids, the solvent, and the water.

In some examples, if the cleaning composition includes the preservative, the cleaning composition can include about 0.001 wt %, about 0.005 wt %, about 0.1wt %, about 0.2 wt %, about 0.3 wt %, about 0.4 wt %, about 0.5 wt %, about 0.6 wt %, about 0.7 wt %, about 0.8 wt %, or about 0.9 wt % to about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, or about 2.3 wt % of the preservative, based on the combined weight of the neutralized tall oil fatty acids, the solvent, and the water. In other examples, if the cleaning composition includes the preservative, the cleaning composition can include about 0.9 wt %, about 1 wt %, about 1.1 wt %, or about 1.2 wt % to about 1.3 wt %, about 1.4 wt %, about 1.5 wt %, about 1.6 wt %, or about 1.7 wt % of the preservative, based on the combined weight of the neutralized tall oil fatty acids, the solvent, and the water.

If the cleaning composition includes the corrosion inhibitor, the cleaning composition can include about 0.001 wt %, about 0.005 wt %, about 0.01 wt %, about 0.05 wt %, about 0.1 wt %, about 0.3 wt %, about 0.5 wt %, about 0.7 wt %, or about 1 wt % to about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, or about 7.5 wt % of the corrosion inhibitor, based on the combined weight of the neutralized tall oil fatty acids, the solvent, and the water.

In some examples, if the cleaning composition includes the base compound, the cleaning composition can include about 0.01 wt %, about 0.05 wt %, about 0.1 wt %, about 0.5 wt %, about 0.7 wt %, or about 1 wt % to about 2 wt %, about 3 wt %, about 4 wt %, about 5 wt %, about 6 wt %, about 7 wt %, about 8 wt %, about 9 wt %, about 10 wt %, or about 10.5 wt % of the base compound, based on the combined weight of the neutralized tall oil fatty acids, the solvent, and the water. In other examples, if the cleaning composition includes the base compound, the cleaning composition can include about 0.2 wt %, about 0.4 wt %, about 0.6 wt %, about 0.7 wt %, about 1 wt %, or about 2 wt % to about 3 wt %, about 4 wt %, about 5 wt %, about 6 wt %, about 7 wt %, about 8 wt %, about 9 wt %, about 10 wt %, about 11 wt %, or about 12 wt % of the base compound, based on the combined weight of the neutralized tall oil fatty acids, the solvent, and the water.

In some examples, if the cleaning composition includes the chelating agent, the cleaning composition can include about 0.001 wt %, about 0.01 wt %, about 0.015 wt %, about 0.02 wt %, or about 0.025 wt % to about 0.03 wt %, about 0.035 wt %, about 0.04 wt %, about 0.05 wt %, about 0.06 wt %, about 0.07 wt %, about 0.08 wt %, about 0.09 wt %, or about 0.1 wt % of the chelating agent, based on the combined weight of the neutralized tall oil fatty acids, the solvent, and the water. In other examples, if the cleaning composition includes the chelating agent, the cleaning composition can include about 0.1 wt %, about 0.3 wt %, about 0.5 wt %, about 0.7 wt %, about 1 wt %, about 1.3 wt %, or about 1.5 wt % to about 2 wt %, about 3 wt %, about 5 wt %, about 7 wt %, about 8.5 wt %, or about 10% wt % of the chelating agent, based on the combined weight of the neutralized tall oil fatty acids, the solvent, and the water. In other examples, if the cleaning composition includes the chelating agent, the cleaning composition can include about 1.3 wt %, about 1.4 wt %, about 1.5 wt %, about 1.7 wt %, about 2 wt %, about 2.3 wt %, or about 2.5 wt % to about 2.7 wt %, about 3 wt %, about 3.2 wt %, about 3.4 wt %, about 3.6 wt %, or about 3.8% wt % of the chelating agent, based on the combined weight of the neutralized tall oil fatty acids, the solvent, and the water.

In some examples, the cleaning composition can include the neutralized tall oil fatty acids, the solvent, the water, and at least one, at least two, at least three, at least four, at least five, or all six of the optional components, i.e., the non-ionic surfactant, the fragrance, the preservative, the corrosion inhibitor, the base compound, and/or the chelating agent. In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, and at least one, two, three, four, five, or all six of the following: about 0.01 wt % to about 30.5 wt % of the non-ionic surfactant, about 0.001 wt % to about 5.1 wt % of the fragrance, about 0.001 wt % to about 2.1 wt % of the preservative, about 0.001 wt % to about 7.1 wt % of the corrosion inhibitor, about 0.01 wt % to about 10.5 wt % of the base compound, and/or about 0.1 wt % to about 10 wt % of the chelating agent, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, and at least one, two, three, four, five, or all six of the following: about 0.01 wt % to about 30.5 wt % of the non-ionic surfactant, about 0.001 wt % to about 5.1 wt % of the fragrance, about 0.001 wt % to about 2.1 wt % of the preservative, about 0.001 wt % to about 7.1 wt % of the corrosion inhibitor, about 0.01 wt % to about 10.5 wt % of the base compound, and/or about 0.1 wt % to about 10 wt % of the chelating agent, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, and at least one, two, three, four, or all five of the following: about 2.5 wt % to about 40 wt % of the non-ionic surfactant, about 0.1 wt % to about 2.3 wt % of the fragrance, about 1 wt % to about 1.6 wt % of the preservative, about 0.2 wt % to about 11.8 wt % of the base compound, and/or about 1.4 wt % to about 3.6 wt % of the chelating agent, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, about 0.01 wt % to about 30.5 wt % of the non-ionic surfactant, and about 0.01 wt % to about 10.5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, about 0.01 wt % to about 30.5 wt % of the non-ionic surfactant, and about 0.01 wt % to about 10.5 wt % of the base compound, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, about 0.01 wt % to about 30.5 wt % of the non-ionic surfactant, about 0.001 wt % to about 5.1 wt % of the fragrance, and about 0.01 wt % to about 10.5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, about 0.01 wt % to about 30.5 wt % of the non-ionic surfactant, about 0.001 wt % to about 5.1 wt % of the fragrance, and about 0.01 wt % to about 10.5 wt % of the base compound, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, about 0.01 wt % to about 30.5 wt % of the non-ionic surfactant, about 0.001 wt % to about 5.1 wt % of the fragrance, about 0.001 wt % to about 7.5 wt % of the preservative, and about 0.01 wt % to about 10.5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, about 0.01 wt % to about 30.5 wt % of the non-ionic surfactant, about 0.001 wt % to about 5.1 wt % of the fragrance, about 0.001 wt % to about 7.5 wt % of the preservative, and about 0.01 wt % to about 10.5 wt % of the base compound, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, about 0.01 wt % to about 30.5 wt % of the non-ionic surfactant, about 0.001 wt % to about 5.1 wt % of the fragrance, about 0.001 wt % to about 2.1 wt % of the preservative, about 0.001 wt % to about 7.5 wt % of the corrosion inhibitor, and about 0.01 wt % to about 10.5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, about 0.01 wt % to about 30.5 wt % of the non-ionic surfactant, about 0.001 wt % to about 5.1 wt % of the fragrance, about 0.001 wt % to about 2.1 wt % of the preservative, about 0.001 wt % to about 7.5 wt % of the corrosion inhibitor, and about 0.01 wt % to about 10.5 wt % of the base compound, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, up to about 30.5 wt % of the non-ionic surfactant, up to about 5.1 wt % of the fragrance, up to about 2.1 wt % of the preservative, up to about 7..5 wt % of the corrosion inhibitor, and up to about 10.5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, up to about 30.5 wt % of the non-ionic surfactant, up to about 5.1 wt % of the fragrance, up to about 2.1 wt % of the preservative, up to about 7..5 wt % of the corrosion inhibitor, and up to about 10.5 wt % of the base compound, where all weight percent values are based on the combined weight of the neutralized tall oil fatty acids, the solvent, and the water.

In some examples, the cleaning composition can include about 0.02 wt % to about 26 wt % of the neutralized tall oil fatty acids, about 0.01 wt % to about 5 wt % of the solvent, about 69 wt % to about 99.97 wt % of water, about 0.01 wt % to about 2 wt % of the non-ionic surfactant, about 0.001 wt % to about 1 wt % of the fragrance, about 0.001 wt % to about 1 wt % of the preservative, about 0.001 wt % to about 2 wt % of the corrosion inhibitor, and about 0.01 wt % to about 5 wt % of the base compound, where all weight percent values are based on the combined weight of the neutralized tall oil fatty acids, the solvent, and the water. In other examples, the cleaning composition can include about 0.02 wt % to about 26 wt % of the neutralized tall oil fatty acids, about 0.01 wt % to about 9 wt % of the solvent, about 65 wt % to about 99.97 wt % of water, about 0.01 wt % to about 2 wt % of the non-ionic surfactant, about 0.001 wt % to about 1 wt % of the fragrance, about 0.001 wt % to about 1 wt % of the preservative, about 0.001 wt % to about 2 wt % of the corrosion inhibitor, and about 0.01 wt % to about 5 wt % of the base compound, where all weight percent values are based on the combined weight of the neutralized tall oil fatty acids, the solvent, and the water.

The components of the cleaning composition can be mixed, blended, combined, or otherwise contacted within one or more mixers or any other suitable device. The mixer can be or include any device, system, or combination of device(s) and/or system(s) capable of batch, intermittent, and/or continuous mixing, blending, contacting, or the otherwise combining of two or more components of the cleaning composition. The cleaning composition can be in the form of a suspension, dispersion, emulsion, or solution. In some examples, the cleaning composition can be in the form of an emulsion. In other examples, the cleaning composition can be in the form of a solution.

Illustrative mixers can include, but are not limited to, mechanical mixer agitation, ejectors, static mixers, mechanical/power mixers, shear mixers, sonic mixers, vibration mixing, e.g., movement of the mixer itself, or any combination thereof. The mixer can include one or more heating jackets, heating coils, internal heating elements, cooling jackets, cooling coils, internal cooling elements, or the like, to regulate the temperature therein. The mixer can be an open vessel or a closed vessel. The components of the cleaning composition can be combined within the mixer under a vacuum, at atmospheric pressure, or at pressures greater than atmospheric pressure. Any two or more components of the cleaning composition can be combined within the mixer at a temperature of about 0° C., about 10° C., about 20° C., or about 30° C. to about 40° C., about 50° C., about 60° C., about 70° C., about 80° C., about 90° C., about 100° C., or greater. The mixer can be capable of producing a homogeneous suspension, dispersion, emulsion, or solution.

The cleaning composition can be produced by mixing, blending, combining, or otherwise contacting the ingredients in any order or sequence. In some examples a tall oil fatty acids can be mixed, blended, combined, or otherwise contacted with one or more neutralizing agents and reacted to produce the neutralized tall oil fatty acids. The neutralized tall oil fatty acids can be contacted with the other ingredients in any order or sequence. In other examples, the tall oil fatty acids, the neutralizing agent, and any one or more of the additional ingredients, e.g., the solvent and the water, can be contacted with one another and the neutralization of the tall oil fatty acids can occur in the presence of the additional ingredient(s). For example, the tall oil fatty acids, the neutralizing agent, the solvent, the water and any one or more of the optional non-ionic surfactant, fragrance, preservative, corrosion inhibitor, and/or base can be combined with one another to produce a mixture. The tall oil fatty acids can be reacted with at least a portion of the neutralizing agent to produce the cleaning composition that includes the neutralized tall oil fatty acids, the solvent, and the water, and any optional additional ingredients that were present.

Neutralization of the tall oil fatty acids, whether in the presence or absence of any additional ingredient(s) in the cleaning composition, can occur at a temperature of about 0° C., about 10° C., about 20° C., or about 30° C. to about 40° C., about 50° C., about 60° C., about 70° C., about 80° C., about 90° C., about 100° C., or greater. Neutralization of the tall oil fatty acids can be accelerated or otherwise improved via the use of heat, agitation, increased time, greater sheer, or any combination.

The tall oil fatty acids that can be neutralized by reaction with the neutralizing agent to produce the neutralized tall oil fatty acids can be or include one or more tall oil fatty acid products separated or otherwise derived from crude tall oil. The term “crude tall oil” refers to a resinous yellow-black, oily liquid obtained as an acidified byproduct in the kraft or sulfate processing of pine wood. The CAS number for crude tall oil (CTO) is 8002-26-4. Crude tall oil includes a mixture of rosin acids, fatty acids, sterols, high-molecular weight alcohols, and other alkyl chain materials. One product that can be derived or recovered via the distillation of crude tall oil is a mixture of tall oil fatty acids in the C₁₆-C₂₄ range and is generally referred to tall oil fatty acids or TOFA.

Tall oil fatty acids can include a mixture of various fatty acids, fatty acid esters, minor amounts of rosin, rosin esters, and/or neutral or unsaponifiable materials. In some examples, the tall oil fatty acids can include about 80 wt %, about 85 wt %, or about 90 wt % to about 95 wt %, about 95 wt %, about 97 wt %, about 99 wt %, or about 99. 9 wt % of fatty acids and/or fatty acid esters; about 10 wt % or less, about 7 wt % or less, about 6 wt % or less, about 5 wt % or less, about 4 wt % or less, about 3 wt % or less, about 2 wt % or less, or about 1 wt % or less of rosin acids and/or rosin acid esters, and about 10 wt % or less, about 7 wt % or less, about 6 wt % or less, about 5 wt % or less, about 4 wt % or less, about 3 wt % or less, about 2 wt % or less, or about 1 wt % or less of neutral or unsaponifiable material, based on a combined weight of the fatty acids, the rosin acids, and the unsaponifiable material. In other examples, the tall oil fatty acids can include about 91 wt %, about 92 wt %, or about 93 wt % to about 95 wt %, about 97 wt %, about 99 wt %, or about 99.9 wt % of fatty acids and/or fatty acid esters; about 6 wt % or less, about 5 wt % or less, about 4 wt % or less, about 3 wt % or less, about 2 wt % or less, or about 1 wt % or less of rosin acids and/or rosin acid esters, and about 3 wt % or less, about 2.5 wt % or less, about 2 wt % or less, about 1.5 wt % or less, or about 1 wt % or less of neutral or unsaponifiable material, based on a combined weight of the fatty acids, the rosin acids, and the unsaponifiable material.

The tall oil fatty acids can include about 30 wt %, about 35 wt %, or about 40 wt % to about 45 wt %, about 50 wt %, or about 55 wt % of oleic acid, based on a total weight of the tall oil fatty acids. The tall oil fatty acids can include about 27 wt %, about 30 wt %, or about 33 wt % to about 37 wt %, about 40 wt %, or about 43 wt % of linoleic acid, based on the total weight of the tall oil fatty acids. The tall oil fatty acids can include about 0.5 wt %, about 1 wt %, or about 1.5 wt % to a high of about 2 wt %, about 3 wt %, or about 4 wt % of stearic acid, based on the total weight of the tall oil fatty acids. The tall oil fatty acids can include about 0.01 wt %, about 0.1 wt %, about 0.3 wt %, or about 0.5 wt % to about 0.7 wt %, about 1 wt %, about 1.3 wt %, or about 1.5 wt % of conjugated linoleic acid, based on the total weight of the tall oil fatty acids. The tall oil fatty acids can include about 0.1 wt %, about 0.3 wt %, or about 0.5 wt % to about 0.7 wt %, about 1 wt %, about 1.5 wt %, or about 2 wt % of palmitic acid, based on the total weight of the tall oil fatty acids. The tall oil fatty acids can include about 0.1 wt %, about 0.3 wt %, or about 0.5 wt % to about 0.7 wt %, about 1 wt %, about 1.5 wt %, or about 2 wt % of linolenic acid, based on the total weight of the tall oil fatty acids. The tall oil fatty acids can include about 0.1 wt %, about 0.3 wt %, or about 0.5 wt % to about 0.7 wt %, about 1 wt %, about 1.5 wt %, or about 2 wt % of palmitic acid, based on the total weight of the tall oil fatty acids. In some examples, the tall oil fatty acids can have a concentration of rosin acids of up to about 7 wt %%, up to about 6 wt %, up to about 5 wt %, up to about 4 wt %, up to about 3 wt %, up to about 2 wt %, or up to about 1 wt %, based on the total weight of the tall oil fatty acids. The tall oil fatty acids can have a concentration of neutral or unsaponifiable material of up to about 5 wt %, up to about 3 wt %, up to about 2 wt %, up to about 1 wt %, or up to about 0.5 wt %, based on the total weight of the tall oil fatty acids. In some examples, the tall oil fatty acids can be free or substantially free of any unsaponifiable material.

In some examples, the tall oil fatty acids can include about 35 wt % to about 50 wt % of oleic acid, about 30 wt % to about 40 wt % of linoleic acid, about 2 wt % to about 3 wt % of stearic acid, up to about 1 wt % of conjugated linoleic acid, up to about 1 wt % of palmitic acid, and up to about 1 wt % of linolenic acid, based on the total weight of the tall oil fatty acids. In other examples, the tall oil fatty acids can include about 45 wt % to about 50 wt % of oleic acid, about 35 wt % to about 40 wt % of linoleic acid, about 2 wt % to about 3 wt % of stearic acid, up to about 1 wt % of conjugated linoleic acid, up to about 1 wt % of palmitic acid, up to about 1 wt % of linolenic acid, and up to about 6 wt % of rosin acids, based on the total weight of the tall oil fatty acids.

In some examples, the tall oil fatty acids can include a greater amount of mono-unsaturated fatty acids, e.g., oleic acid, relative to di-unsaturated fatty acids, e.g., linoleic acid. For example, the tall oil fatty acids can have a weight ratio of mono-unsaturated fatty acids to di-unsaturated fatty acids of about 1.05:1, about 1.1:1, about 1.15:1, about 1.2:1, or about 1.25:1 to about 1.3:1, about 1.35:1, about 1.4:1, about 1.45:1, or about 1.5:1. In other examples, the tall oil fatty acids can include a greater amount of di-unsaturated fatty acids, e.g., linoleic acid, relative to mono-unsaturated fatty acids, e.g., oleic acid. For example, the tall oil fatty acids can have a weight ratio of di-unsaturated fatty acids to mono-unsaturated fatty acids of about 1.05:1, about 1.1:1, about 1.15:1, about 1.2:1, or about 1.25:1 to about 1.3:1, about 1.35:1, about 1.4:1, about 1.45:1, or about 1.5:1.

The tall oil fatty acids can have an acid value of about 185, about 187, about 190, or about 193 to about 195, about 197, about 200, about 203, about 205, about 207, or about 210. As used herein, the “acid value” is the mass of potassium hydroxide (KOH) in milligrams that is required to neutralize one gram of a given composition (mg KOH/g), e.g., the tall oil fatty acids. In a typical procedure, a known amount of a given composition is dissolved in an organic solvent and is titrated with a solution of potassium hydroxide of known concentration. The acid value can be determined by using a potassium hydroxide solution that contains phenolphthalein as a color indicator or using potentiometric analysis. Standard methods used for determining acid values can include ASTM D465-15, AOCS Te 1a-64-64 (2017), and AOCS Da 14-48 (2017).

The tall oil fatty acids can have a saponification value of about 188, about 190, about 192, or about 195 to about 197, about 200, about 203, about 205, about 207, about 210, or about 215. The saponification number is the milligrams of potassium hydroxide (KOH) required to saponify a 1 gram sample and corresponds to the sum of an acid value and an ester value. When the saponification value is measured, a sample can be saponified with approximately 0.5N potassium hydroxide in an alcohol solution, and excess potassium hydroxide can be titrated with 0.5N hydrochloric acid. A standard method for determining the saponification value can include AOCS Cd-25 (2017), PCTM 16 (Issued 1996), and ASTM D464-15.

The tall oil fatty acids can have an iodine value of about 120, about 123, about 123, or about 127 to about 129, about 130, about 133, or about 135. To measure the iodine value, the amount of halogen absorbed by a sample of the tall oil fatty acids can be measured while the halogen acts on the sample. The amount of halogen absorbed can be converted to iodine and expressed in grams per 100 grams of the sample. The iodine value is grams of iodine absorbed by 100 grams of tall oil fatty acids, and the degree of unsaturation of fatty acids in the sample increases with the iodine value. A chloroform or carbon tetrachloride solution can be prepared as a sample, and an alcohol solution of iodine and mercuric chloride or a glacial acetic acid solution of iodine chloride can be added to the sample. After the sample is allowed to stand, the iodine that remains without causing any reaction can be titrated with a sodium thiosulfate standard solution, thus calculating the amount of iodine absorbed. Standard methods for determining the iodine value of tall oil fatty acids can include AOCS Cd 1c-85 (2017), AOCS Cd 1-25 (2017), AOCS Tg 1a-64 (2017), and ASTM D5768 (2014).

The tall oil fatty acids can have a Gardner color of about 8 or less, about 7 or less, about 6 or less, about 5 or less, about 4 or less, about 3 or less, about 2 or less, or about 1 or less. A standard method for determining the Gardner color can include ASTM D1544-04 (2010).

Illustrative, commercially available tall oil products such as XTOL® 100, XTOL® 101, XTOL® 300, and XTOL® 304 (all previously available from Georgia-Pacific Chemicals LLC, Atlanta, Ga., and similar or equivalent products are now available from Ingevity South Carolina LLC) all contain saturated and unsaturated fatty acids in the C₁₆-C₂₄ range, as well as minor amounts of rosin acids. It should be noted that crude tall oil can be derived from various natural sources; and thus, the composition of the tall oil can vary among the various natural sources.

The neutralizing agent can be or include any compound capable of reacting with the tall oil fatty acids to produce the neutralized tall oil fatty acids. Illustrative neutralizing agents can include, but are not limited to, hydroxides, e.g., ammonium hydroxide, alkali metal hydroxides, and/or alkaline earth metal hydroxides; oxides, e.g., alkali metal oxides and/or alkaline earth metal oxides; amines; or any mixture thereof. Illustrative hydroxides can include, but are not limited to, ammonium hydroxide, sodium hydroxide, potassium hydroxide, lithium hydroxide, magnesium hydroxide, calcium hydroxide, barium hydroxide, or any mixture thereof. Illustrative oxides can include, but are not limited to, sodium oxide, potassium oxide, lithium oxide, magnesium oxide, calcium oxide, barium oxides, or any mixture thereof. Illustrative amines can include, but are not limited to, methylamine, ethylamine, triethylamine, n-propylamine, isopropylamine, n-butylamine, isobutylamine, sec-butylamine, t-butylamine, n-hexylamine, cyclohexyl amine, n-octylamine, n-decylamine, n-dodecylamine, diisopropylamine, diisobutylamine, dicyclohexylamine, bis(2-ethylhexyl)amine, didecylamine, N,N-dimethyl-N′ ethylethlenediamine, pyrrolidine, piperidine, hexametheneimine, 2-pyrrolidinemethanol, heputamethyleneimine, 2-pyrrolidinie, piperazine, an alkanolamine such as monoethanolamine, diethanolamine, triethanolamine, isopropanolamine, diisopropanolamine, isobutanolamine, and/or 2-amino-2-methyl-1-propanol (aminomethyl propanol), a glycolamine such as diethylene glycolamine and/or triethylene glycol amine, or any mixture thereof. In some examples, the neutralizing agent can be or include potassium hydroxide, ammonium hydroxide, or a mixture thereof.

The solvent can be or include any desired solvent. In some examples, the solvent can be capable of improving the clarity of the cleaning composition and/or improving the streaking value of the cleaning composition can be used. Illustrative solvents can be or include, but are not limited to, alcohols, ketones, glycols, ethers, dibasic esters, glycol ethers, or any mixture thereof. Illustrative alcohols can be or include, but are not limited to, methanol, ethanol, isopropyl alcohol, butanol, or any mixture thereof. Illustrated ketones can be or include, but are not limited to, acetone, acetophenone, butanone, cyclopentanone, ethyl isopropyl ketone, isophorone, or any mixture thereof. Illustrative glycols can be or include, but are not limited to, propylene glycol, propanedio, ethylene glycol, butylene glycol, triethylene glycol, diethylene glycol, or any mixture thereof. Illustrative dibasic esters can be or include, but are not limited to, diethyl malonate, dimethyl adipate, dimethyl glutarate and dimethyl succinate, or any mixture thereof. Illustrated glycol ethers can be or include, but are not limited to, dipropylene glycol methyl ether, dipropylene glycol n-butyl ether, dipropylene glycol n-propyl ether, propylene glycol diacetate, propylene glycol methyl ether, propylene glycol n-butyl ether, propylene glycol n-propyl ether, propylene glycol phenyl ether, tripropylene glycol methyl ether, tripropylene glycol n-butyl ether, tripropylene glycol n-butyl ether, dipropylene glycol dimethyl ether, or any mixture theoref In some examples, the solvent can be or include propylene glycol n-butyl ether sold under the name DOWANOL® PnB, which is available from The Dow Chemical Company.

The water can be or include any water. For example, the water can be or include distilled water, deionized water, reverse osmosis water, natural mineral water, spring water, distilled water, or any mixture thereof. In some examples, the water can be or include deionized water. In some examples, the water can be or include distilled water. In other examples, the water can be or include reverse osmosis water.

If the cleaning composition includes the base compound, the base compound can be or include any one or more of the neutralizing agents discussed and described above. It should be noted that if the cleaning composition includes the base compound, the base compound can be the same compound or mixture of compounds that was used to produce the neutralized tall oil fatty acids. For example, potassium hydroxide and/or ammonium hydroxide can be used as the neutralizing agent to produce the neutralized tall oil fatty acids. An excess of the neutralizing agent can be contacted with the tall oil fatty acids and any excess neutralizing agent not consumed during production of the neutralized fatty acids could remain and would be considered the base compound in the cleaning composition. It should also be noted that if the cleaning composition includes the base compound, the base compound can be a different compound than the neutralizing agent used to produce the neutralized tall oil fatty acids. For example, potassium hydroxide could be used to produce the neutralized tall oil fatty acids and ammonium hydroxide could be added as the base compound in making the cleaning composition. Other suitable base compounds can include alkali salts. Illustrative alkali salts can be or include, but are not limited to, sodium carbonate, sodium acetate, sodium sulfide, potassium carbonate, or any mixture thereof.

If the cleaning agent includes the non-ionic surfactant, any suitable non-ionic surfactant can be used. Suitable non-ionic surfactant can include, but are not limited to, alcohol ethoxylates (AEs), alkyl polyglucosides, nonylphenol ethoxylates, octyphenol ethoxylates, ethoxylated and propoxylated surfactants, or any mixture thereof. Suitable alcohol ethoxylates can include, but are not limited to, linear alcohol ethoxylates, secondary alcohol ethyoxylates, branched secondary alcohol ethoxylates, or any mixture thereof. Illustrative linear alcohol ethoxylates can include, but are not limited to, C₉₋₁₁Pareth-3, C₉₋₁₁Pareth-6, C₉₋₁₁Pareth-8, Undeceth-3, Undeceth-5, Undeceth-7, Undeceth-9, C₁₂₋₁₃ Pareth-3, C₁₂₋₁₃ Pareth-7, C₁₂₋₁₅ Pareth-3, C₁₂₋₁₃ Pareth-7, C₁₂₋₁₅ Pareth-9, or any mixture thereof. Illustrative secondary alcohol ethoxylates can include, but are not limited to, C12-14; 7-40 moles EO. Illustrative branched secondary alcohol ethoxylates can include, but are not limited to, polyethylene glycol mono(3,5-dimethyl-1-isobutylhexyl) ether. Illustrative nonylphenol ethoxylates can include, but are not limited to, nonylphenol polyethylene glycol ether (4-70 moles EO). Illustrative octylphenol ethoxylates can include, but are not limited to, polyethylene glycol octylphenyl ether (4.5-55 moles EO). Illustrative ethoxylated/Propoxylated 2-Ethyl Hexanol EO-PO (CASRN 64366-70-7). Illustrative alkyl polyglucosides can include, but are not limited to, Decyl/undecyl glucosides, lauryl glucosides, butyl glucosides, caprylyl/capryl glucosides, methyl glucosides, C8-10 alkyl polyglucoside, cocoglucoside, C8-14 alkyl polyglucoside, or any mixture thereof. If the cleaning composition includes the non-ionic surfactant, in some example, the non-ionic surfactant can be or include APG® 325N, which is available from the BASF Corporation.

If the cleaning composition includes the fragrance, any fragrance capable of providing a desired odor to the cleaning composition can be used. Illustrative fragrances that are commercially available can be or include, but are not limited to, Symrise Sunshine Herbs #737173, Clear Springs #997597, #380423, and #997598, or any mixture thereof.

If the cleaning composition includes the preservative, any preservative capable of preventing or substantially preventing any microbial growth can be used. Illustrative preservatives can be or include, but are not limited to, methylisothiazolinone, benzoisothiazolinone, methylchloroisothiazolinone, octylisothiazolinone, phenoxyethanol, caprylyl glycol, a parabens and sodium salts of parabens, butylated hydroxytoluene, dehydroacetic acid, benzoic acid, sodium benzoate, formaldehyde releasers such as a quaternary ammonium salt (quaternum-15), imidazolindinyl urea, diazolindnyl urea, DMDM hydantoin, 2-bromo-2-nitropropane-1,3-diol, 5-bromo-5-nitro-1,3-dioxane, tris(hydroxymethyl nitromethane, or any mixture thereof. Illustrative parabens can be or include, but are not limited to, methylparaben, ethylparaben, propylparaben, butyl paraben, isobutylparaben, isopropylparaben, benzylparaben, sodium salts thereof, or any mixture thereof. If the cleaning composition includes a preservative, in some examples, the preservative can be or include BIOBAN® 425, which includes 2-methyl-4-isothiazolin-3-one (MIT) and 2-n-Octyl-4-isothiazolin-3-one (OIT) in a proprietary carrier that is available from The Dow Chemical Company; NEOLONE® PH100, which includes phenoxyethanol and is available from The Dow Chemical Company; and/or OPTIPHEN® 300, which includes phenoxyethanol and caprylyl glycol and is available from Ashland.

If the cleaning composition includes a corrosion inhibitor, any corrosion inhibitor capable of preventing or reducing the corrosion of a metal when in contact with the cleaning composition can be used. Illustrative corrosion inhibitors can be or include, but are not limited to, sodium mercaptobenzothiazole, polyether phosphate, benzotriazole, or any mixture thereof.

If the cleaning composition includes the chelating agent, any chelating agent capable of protecting the cleaning solution from hardness ions that may be present. For example, if the water used in the cleaning composition is or includes hard water, the chelating agent can protect the cleaning solution from the hardness ions present in the hard water. Illustrative chelating agents can be or include, but are not limited to, methylglycine N,N-diacetic acid (MGDA), diethylenetriaminepentaacetic acid (DTPA), ethylenediaminetetraacetic acid (EDTA), nitriloacetic acid (NTA), iminodisuccinate (IDS), ethylenediamine-N,N′-disuccinic acid (EDDS), ethyleneglycol bis(2-aminoethylether)-N,N,N′,N′-tetraacetic acid (EGTA), trans-1,2- diaminocyclohexane tetraacetic acid (CDTA), N,N-Dicarboxymethyl glutamic acid tetrasodium salt (GLDA), ethanoldiglycinic acid (EDG), Hydroxyethylethylenediaminetriacetic acid (HEDTA), sodium salts thereof, potassium salts thereof, or any mixture thereof. Other illustrative chelating agents can be or include, but are not limited to, sodium gluconate, glucoheptonate, citric acid, sodium tetraborate salts of mono-, penta-, and/or decahydrate, or any mixture thereof. Illustrative commercially available chelants can be or include, but are not limited to, TRILON® M and/or TRILON® B (MGDA and EDTA, respectively, available from BASF), VERSENE® 100 (EDTA, available from Dow Chemical), and/or DISSOLVINE® M (MGDA, available from AkzoNobel).

The cleaning composition can be used to clean a surface via any desired manner. In some examples, the cleaning composition can be applied or otherwise contacted with a substrate to produce a pre-moistened substrate that can be used to clean the desired surface. For example, the cleaning composition can be adsorbed onto and/or into the substrate, e.g., a woven or non-woven wipe or wiper, and the surface desired to be cleaned can be wiped with the pre-moistened substrate containing the cleaning composition thereon and/or therein. In some examples, the substrate can be pre-saturated with the cleaning composition and stored in a container and can be removed therefrom when a surface needs to be cleaned. The pre-moistened or pre-saturated substrate, e.g., a wipe, can include about 5 wt %, about 20 wt %, about 50 wt %, about 75 wt %, or about 100 wt % to about 200 wt %, about 300 wt %, about 400 wt %, about 500 wt %, about 600 wt %, or more of the cleaning composition, based on a dry weight of the substrate.

For non-woven substrates, any suitable matrix of fibers or filaments that can be consolidated into a non-woven web can be used. Non-woven substrates can be formed via any suitable process or combination of processes. Illustrative processes suitable for making non-woven substrates can include, but are not limited to, meltblowing, spunbonding, bonded carded web, air laying, wet laying, solution spinning, pattern-roll bonding, through-air bonding, hydro entangling, and other processes. Staple length fibers, continuous filaments, or blends of fibers and/or filaments having the same or different compositions can be used to form the substrate. Staple lengths are selected in the range of about 1 cm to about 8 cm, or about 2.5 cm to about 5 cm. The non-woven substrate can be a single layer web or a multi-layer web. A non-woven web made of multiple layers can have similar materials in each layer or can have different materials in each layer. The substrate can also be a multilayer laminate. Illustrative processes suitable for making non-woven substrates can include, but are not limited to, those discussed and described in U.S. Pat. Nos. 797,749; 3,485,706; 4,014,635; 4,081,319; 4,200,488; 4,640,810; 5,958,186; Canadian Patent No. 841,938; and PCT International Publication No. WO 03/099886.

Fibers that can be used to produce woven and non-woven substrates can be or include synthetic fibers and/or natural fibers. Illustrative synthetic fibers can be or include, but are not limited to, polyester fibers, nylon fibers, polyethylene fibers, and polypropylene fibers. Illustrative natural fibers can be or include, but are not limited to, cotton, wool, silk, wood pulp fibers, e.g., cellulose fibers, bast fibers, e.g., fibers found in the stalks of the flax, hemp, jute, ramie, nettle, Spanish broom, and kenaf plants, or any mixture thereof. In some examples, the substrate can be made from a mixture of both synthetic fibers and natural fibers. In some examples, the substrate can be made from, at least in part, flax fibers.

In some examples, the fibers can have a mean length of about 5 mm to about 150 mm. In other examples, the fibers can have a mean length of about 6 mm, about 10 mm, about 15 mm, about 20 mm, about 25 mm, about 30 mm, about 35 mm, about 40 mm, about 45 mm, or about 50 mm to about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, about 145 mm, or about 150 mm.

In some examples, the substrate can be or include a non-woven substrate that can incorporate a biobased thermal bonding component that can allow the fibers to sufficiently maintain inter fiber bonds during wet agitation and drying (or heating) processes. In some examples, the biobased thermal bonding fibers can be or include, but are not limited to, fibers containing or made from polylactic acid (PLA). The biobased thermal bonding fibers can be incorporated into a biobased nonwoven fabric, which can be thermally bonded. The fibers can be thermally bonded using any suitable process. In some examples, the fibers can be thermally bonded via the process discussed and described in PCT International Publication No. WO/2005/025865.

The nonwoven substrates or fabrics can be used as a wiper. For example, the nonwoven fabrics can be impregnated with a wetting solution, the cleaning composition discussed and described herein. In some examples, the nonwoven fabrics and wipers can be biodegradable according to ASTM International D6400 or D6868 standard tests. In some examples, the fibers that can be thermally bonded with the biobased thermal bonding fibers can be or include, but are not limited to, bast fibers. The bast fiber is a flax fiber, a hemp fiber, a jute fiber, a ramie fiber, a nettle fiber, a Spanish broom fiber, a kenaf plant fiber, or any combination thereof.

In some examples, the polyactic acid fibers have a mean length of about 3 mm, about 5 mm, about 10 mm, about 15 mm, or about 20 mm to about 25 mm, about 30 mm, about 35 mm, about 40 mm, about 45 mm, about 50 mm, or about 55 mm. The denier of the polyactic acid fibers can be about 3.6 to about 4.4 or about 1.5 to about 4.4.

The amount of bast fibers that can be incorporated into the nonwoven fabric can be tailored, depending on the nonwoven fabric application. In some examples, the nonwoven fabric can include a majority (more than 50 wt %) bast fibers. In other examples, the amount of bast fibers that can be incorporated into the nonwoven fabric can be about 55 wt %, about 60 wt %, about 65 wt %, or about 70 wt % to about 80 wt %, about 85 wt %, about 90 wt %, about 92 wt %, or about 95 wt %, based on a total weight of the nonwoven fabric. In some examples, the nonwoven fabric can include about 5 wt %, about 8 wt %, about 10 wt %, about 15 wt %, or about 20 wt % to about 25 wt %, about 30 wt %, about 35 wt %, or about 40 wt % of the polyactic acid fibers, based on the total weight of the nonwoven fabric.

Illustrative substrates that can be pre-moistened or pre-saturated with the cleaning composition can include the substrates or wipes discussed and described in U.S. Patent Application Nos. 2009/0308551; 2011/0272304; 2012/0144611; 2013/0299106; 2014/0066872; 2014/0273704; 2015/0000851; 2015/0017215; 2015/0122435; 2015/0122436; 2015/0135457; 2015/0144157; 2015/0144158; 2015/0164295; 2015/0173581; 2015/0173582; 2015/0173583; 2015/0182092; 20150/176215; 2015/0337496; 2016/0201239; 2016/0221043; and 2016/0227977; and U.S. Pat. Nos. 7,252,741; 7,682,488; 8,864,944; 8,980,011; 8,980,055; 9;005;738; 9,051,691; 9,057,158; 9,282,871; 9,320,403; 9,345,374; 9,345,375; 9,345,376; 9,345,377; 9,345,378; 9,370,292; 9,382,665; 9;439;549; 9,492,049; and 9,510,722.

In some examples, the cleaning composition can be stored in a manually pumped spray bottle and sprayed onto a surface and a paper towel, cloth rag, sponge, or other cleaning aid can be used to wipe the surface to reduce an amount of or remove any dirt or other contaminant on the surface. In some examples, the cleaning composition can be stored in an aerosol can and sprayed onto a surface and a paper towel, cloth rag, sponge, or other cleaning aid can be used to wipe the surface to reduce an amount of or remove any dirt or other contaminant on the surface. In other examples, the cleaning composition can be absorbed onto and/or into a sponge, woven rag or towel, or any other cleaning aid capable of retaining the cleaning composition therein and/or thereon until a user desires to use the pre-saturated cleaning aid to clean a surface. In other examples, the cleaning composition can be stored in a container, e.g., a jar or bottle, and the cleaning composition can be brushed, poured, or otherwise transferred from the container onto the surface to be cleaned.

Illustrative surfaces that can be cleaned with the cleaning composition can include, but are not limited to, ceramic, quartz, granite, marble, glazed and unglazed tile, brick, porcelain, stone surfaces, glass, metal, e.g., stainless steel and chrome, polymeric, e.g., vinyl, polyester, and fiberglass, wood, cement, linoleum, enamel, and the like. The surface can be a porous or a nonporous surface. In some examples, the surface can include stainless steel surfaces such as those found on residential and commercial kitchen equipment, e.g., refrigerators, tables, counter tops, ovens, dishwashers, mixers, stoves, vent hoods, sinks, and the like.

The amount of the cleaning composition contacted with the surface to be cleaned can be sufficient to form a coating of the cleaning composition on the surface. In some examples, at least a portion of the cleaning composition can be removed from the surface. For example, all of the cleaning composition can be removed from the surface along with at least a portion of any dirt or other contaminant that may have been on the surface. In another example, a portion of the cleaning composition can be removed along with at least a portion of any dirt or other contaminant and a portion of the cleaning composition can remain on the surface. The portion of the cleaning composition that can remain on the surface can form a coating, e.g., a thin film, on the surface. The coating can provide a surface that can be resistant to smudges, e.g., fingerprints.

The cleaning solution and substrates, e.g., woven or non-woven wipes, that have been pre-moistened or pre-saturated with the cleaning solution can meet or exceed the requires of the USP <51> 28 day preservative efficacy test containing a yeast, mold, gram positive and gram negative aerobic/anaerobic bacteria.

In some examples, the cleaning composition can be formulated to be primarily a bio-based cleaning composition. For example, one can select particular ingredients in making the cleaning composition that can produce a cleaning composition made of at least 50 wt % bio-based ingredients, at least 60 wt % bio-based ingredients, at least 70 wt % bio-based ingredients, at least 80 wt % bio-based ingredients, at least 90 wt % bio-based ingredients, or 100% bio-based ingredients.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

Eight cleaning compositions (Examples 1-8) were prepared according to the following procedure. The amount of each component used to make each cleaning composition is shown in Tables 1 and 2 below. A tall oil fatty acids (XTOL® 101 from Georgia-Pacific Chemicals LLC) and a neutralizing agent (potassium hydroxide, 2-amino-2-methyl-1-propanol, and/or ammonium hydroxide) were mixed with one another and under agitation reacted to produce a neutralized tall oil fatty acids. The pH was monitored and a sufficient amount of the neutralizing agent was added until the desired pH was reached. For each example, the neutralized tall oil fatty acids was mixed with the remaining components under agitation that are shown in Tables 1-2 to produce the cleaning solution.

TABLE 1

| Component | | Ex. 1 | Ex. 2 | Ex. 3 |
|---|---|---|---|---|
| Deionized Water | Deionized Water | 99.38% | 99.42% | 99.40% |
| Fatty acids, tall oil | XTOL ® 101 | 0.20% | 0.20% | 0.20% |
| Potassium Hydroxide | Potassium Hydroxide | n/a | n/a | n/a |
| | (45% aq. Soln.) | | | |
| 2-Amino-2-methyl-1- | AMP-95 ® | 0.32% | 0.20% | 0.20% |
| propanol | | | | |
| Decyl/Undecyl Glycoside | APG ® 325N | n/a | n/a | n/a |
| 1-Butoxy-2-propanol | DOWANOL ® PNB | 0.10% | 0.10% | 0.10% |
| Ammonium hydroxide | Ammonium Hydroxide | n/a | n/a | n/a |
| | (29% aq. Soln.) | | | |
| Fragrance, | Sunshine Herbs | n/a | n/a | n/a |
| composition unknown | #737173 | | | |
| 2-Methyl-4-isothiazolin- | Bioban 425 | n/a | 0.08% | 0.08% |
| 3-one & 2-n-Octy1-4- | | | | |
| isothiazolin-3-one | | | | |
| Phenoxyethanol and | OPTIPHEN ® 300 | n/a | n/a | n/a |
| Caprylyl Glycol | | | | |
| NEOLONE ® PH 100 | Phenoxyethanol | n/a | n/a | n/a |
| Sodium Benzoate | Sodium Benzoate | n/a | n/a | 0.03% |
| pH | | 10.31 | 10 | 10.21 |
| Solids (%) | | 0.29% | 0.39% | 0.38% |
| Microbial Test | | Pass | Pass | NT |

Examples 1 and 2 were subjected to the USP <51> 28 day preservative efficacy test and passed. Example 3 included sodium benzoate to assess the compatibility of the cleaning composition with corrosion inhibitors for aerosol application. Example 3 was also tested for substrate compatibility and qualitative coating assessment.

TABLE 2

| Component | | Ex. 4 | Ex. 5 | Ex. 6 | Ex. 7 | Ex. 8 |
|---|---|---|---|---|---|---|
| Deionized Water | Deionized Water | 97.62% | 97.57% | 99.18% | 98.96% | 99.11% |
| Fatty acids, tall oil | XTOL ® 101 | 0.20% | 0.20% | 0.20% | 0.15% | 0.15% |
| Potassium | Potassium | n/a | n/a | 0.12% | 0.06% | 0.06% |
| Hydroxide | Hydroxide | | | | | |
| | (45% aq. Soln.) | | | | | |
| 2-Amino-2-methyl- | AMP-95 ® | n/a | n/a | n/a | n/a | n/a |
| 1-propanol | | | | | | |
| Decyl/Undecyl | APG ® 325N | 1.00% | 1.00% | 0.25% | 0.50% | 0.50% |
| Glycoside | | | | | | |
| 1-Butoxy-2-propanol | DOWANOL ® | 1.00% | 1.00% | 0.13% | 0.25% | 0.10% |
| | PNB | | | | | |
| Ammonium hydroxide | Ammonium | 0.10% | 0.10% | 0.10% | 0.05% | 0.05% |
| | Hydroxide | | | | | |
| | (29% aq. Soln.) | | | | | |
| Fragrance, composition | Sunshine Herbs | n/a | 0.05% | 0.03% | 0.03% | 0.03% |
| unknown | #737173 | | | | | |
| 2-Methyl-4-isothiazolin- | Bioban 425 | 0.08% | 0.08% | n/a | n/a | n/a |
| 3-one & 2-n-Octyl-4- | | | | | | |
| isothiazolin-3-one | | | | | | |
| Phenoxyethanol and | OPTIPHEN ® | n/a | n/a | n/a | n/a | n/a |
| Caprylyl Glycol | 300 | | | | | |
| NEOLONE ® pH 100 | Phenoxyethanol | n/a | n/a | n/a | n/a | n/a |
| Sodium Benzoate | Sodium Benzoate | n/a | n/a | n/a | n/a | n/a |
| pH | | 8.63 | 8.65 | 10.71 | 10.05 | 10.5 |
| Solids (%) | | NT | NT | 0.49% | 0.46% | 0.48% |
| Microbial Test | | NT | NT | NT | NT | NT |
| | | | | | 60% | 80% |
| | | | | | bio-based | bio-based |

Examples 7 and 8 were formulated to be a 60% and an 80% bio-based composition, respectively. Examples 4, 5, and 6 were prepared to evaluate the amount of fragrance loading for end use application.

Another three cleaning compositions (Examples 9-11) were prepared with the amount of each component used to make each cleaning composition shown in Table 3 below.

TABLE 3

| | | Example | Example | Example |
|---|---|---|---|---|
| Component | | 9 | 10 | 11 |
| Deionized Water | Deionized Water | 99.01% | 98.60% | 98.60% |
| Fatty acids, tall oil | XTOL ® 101 | 0.15% | 0.15% | 0.15% |
| Potassium Hydroxide | Potassium | 0.16 | 0.07 | 0.07% |
| | Hydroxide | | | |
| | (45% aq. Soln.) | | | |
| 2-Amino-2-methyl- | AMP-95 ® | n/a | n/a | n/a |
| 1-propanol | | | | |
| Decyl/Undecyl | APG ® 325N | 0.50% | 0.50% | 0.50% |
| Glycoside | | | | |
| 1-Butoxy-2- | DOWANOL ® | 0.10% | 0.10% | 0.10% |
| propanol | PNB | | | |
| Ammonium | Ammonium | 0.05% | 0.05% | 0.05% |
| hydroxide | Hydroxide | | | |
| | (29% aq. Soln.) | | | |
| Fragrance, | Sunshine Herbs | 0.03% | 0.03% | 0.03% |
| composition | #737173 | | | |
| unknown | | | | |
| 2-Methyl-4- | Bioban 425 | n/a | n/a | n/a |
| isothiazolin- | | | | |
| 3-one & 2-n-Octyl- | | | | |
| 4-isothiazolin-3-one | | | | |
| Phenoxyethanol and | OPTIPHEN ® | n/a | 0.50% | n/a |
| Caprylyl Glycol | 300 | | | |
| NEOLONE ® PH | Phenoxyethanol | n/a | n/a | 0.5 |
| 100 | | | | |
| Sodium Benzoate | Sodium | n/a | n/a | n/a |
| | Benzoate | | | |
| pH | | 11.8 | 10.5 | 10.5 |
| Solids (%) | | NT | NT | NT |
| Microbial Test | | NT | NT | NT |

Four concentrated cleaning compositions (Examples 12-15) were prepared according to the following procedure. The amount of each component used to make each cleaning composition is shown in Tables 4 below. A tall oil fatty acids (XTOL® 100 from Georgia-Pacific Chemicals LLC) and a neutralizing agent (potassium hydroxide) were mixed with one another and under agitation reacted to produce a neutralized tall oil fatty acids. The pH was monitored and a sufficient amount of the neutralizing agent was added until the desired pH was reached. For each example, the neutralized tall oil fatty acids was mixed with the remaining components under agitation that are shown in Table 4 to produce the concentrated cleaning solutions.

TABLE 4

| Component | | Ex. 12 | Ex. 13 | Ex. 14 | Ex. 15 |
|---|---|---|---|---|---|
| Deionized Water | Deionized Water | 95.42% | 90.68% | 73.91% | 48.01% |
| Fatty acids, tall oil | XTOL ® 100 | 0.70% | 1.40% | 3.74% | 7.50% |
| Potassium Hydroxide | Potassium Hydroxide | 0.30% | 0.60% | 1.72% | 3.44% |
| | (45% aq. Soln.) | | | | |
| Decyl/Undecyl | APG ® 325N | 2.43% | 5.00% | 12.48% | 24.96% |
| Glycoside | | | | | |
| 1-Butoxy-2-propanol | DOWANOL ® PNB | 0.75% | 1.50% | 2.50% | 5.00% |
| Ammonium | Ammonium Hydroxide | 0.26% | 0.52% | 3.74% | 7.48% |
| hydroxide | (29% aq. Soln.) | | | | |
| Fragrance, | Sunshine Herbs | 0.15 | 0.30% | 0.74% | 1.48% |
| composition | #737173 | | | | |
| unknown | | | | | |
| Methyl Glycine | TRILON ® M | n/a | n/a | 1.17% | 2.13% |
| Diacetic Acid | | | | | |

Embodiments of the present disclosure further relate to any one or more of the following paragraphs:

1. A cleaning composition, comprising: about 0.02 wt % to about 26 wt % of a neutralized tall oil fatty acids; about 0.01 wt % to about 5 wt % of a solvent; and about 69 wt % to about 99.97 wt % of water, wherein all weight percent values are based on a combined weight of the neutralized tall oil fatty acids, the solvent, and the water.

2. A pre-moistened wipe for cleaning a surface, comprising: a substrate; and a cleaning composition, wherein the cleaning composition comprises: about 0.02 wt % to about 26 wt % of a neutralized tall oil fatty acids; about 0.01 wt % to about 5 wt % of a solvent; and about 69 wt % to about 99.97 wt % of water, wherein all weight percent values are based on a combined weight of the neutralized tall oil fatty acids, the solvent, and the water.

3. A process for cleaning a surface, comprising: contacting at least a portion of a surface with a cleaning composition to produce a treated surface; and removing at least a portion of the cleaning composition from the treated surface, wherein the cleaning composition comprises: about 0.02 wt % to about 26 wt % of a neutralized tall oil fatty acids; about 0.01 wt % to about 5 wt % of a solvent; and about 69 wt % to about 99.97 wt % of water, wherein all weight percent values are based on a combined weight of the neutralized tall oil fatty acids, the solvent, and the water.

4. A process for making a cleaning composition, comprising: reacting a tall oil fatty acids with at least a portion of a neutralizing agent to produce a neutralized tall oil fatty acids; combining the neutralized tall oil fatty acids, a solvent, and water to produce the cleaning composition, wherein the cleaning composition comprises: about 0.02 wt % to about 26 wt % of the neutralized tall oil fatty acids; about 0.01 wt % to about 5 wt % of the solvent; and about 69 wt % to about 99.97 wt % of water, wherein all weight percent values are based on a combined weight of the neutralized tall oil fatty acids, the solvent, and the water.

5. A process for making a cleaning composition, comprising: combining a tall oil fatty acids, a neutralizing agent, a solvent, and water to produce an initial composition; and reacting the tall oil fatty acids with at least a portion of the neutralizing agent to produce a cleaning composition comprising a neutralized tall oil fatty acids, the solvent, and the water, wherein the cleaning composition comprises: about 0.02 wt % to about 26 wt % of the neutralized tall oil fatty acids; about 0.01 wt % to about 5 wt % of the solvent; and about 69 wt % to about 99.97 wt % of water, wherein all weight percent values are based on a combined weight of the neutralized tall oil fatty acids, the solvent, and the water.

6. A cleaning composition, comprising: about 0.02 wt % to about 26 wt % of a neutralized tall oil fatty acids; about 0.01 wt % to about 9 wt % of a solvent; and about 65 wt % to about 99.97 wt % of water, wherein all weight percent values are based on a combined weight of the neutralized tall oil fatty acids, the solvent, and the water.

7. A pre-moistened wipe for cleaning a surface, comprising: a substrate; and a cleaning composition, wherein the cleaning composition comprises: about 0.02 wt % to about 26 wt % of a neutralized tall oil fatty acids; about 0.01 wt % to about 9 wt % of a solvent; and about 65 wt % to about 99.97 wt % of water, wherein all weight percent values are based on a combined weight of the neutralized tall oil fatty acids, the solvent, and the water.

8. A process for cleaning a surface, comprising: contacting at least a portion of a surface with a cleaning composition to produce a treated surface; and removing at least a portion of the cleaning composition from the treated surface, wherein the cleaning composition comprises: about 0.02 wt % to about 26 wt % of a neutralized tall oil fatty acids; about 0.01 wt % to about 9 wt % of a solvent; and about 65 wt % to about 99.97 wt % of water, wherein all weight percent values are based on a combined weight of the neutralized tall oil fatty acids, the solvent, and the water.

9. A process for making a cleaning composition, comprising: reacting a tall oil fatty acids with at least a portion of a neutralizing agent to produce a neutralized tall oil fatty acids; combining the neutralized tall oil fatty acids, a solvent, and water to produce the cleaning composition, wherein the cleaning composition comprises: about 0.02 wt % to about 26 wt % of the neutralized tall oil fatty acids; about 0.01 wt % to about 9 wt % of the solvent; and about 65 wt % to about 99.97 wt % of water, wherein all weight percent values are based on a combined weight of the neutralized tall oil fatty acids, the solvent, and the water.

10. A process for making a cleaning composition, comprising: combining a tall oil fatty acids, a neutralizing agent, a solvent, and water to produce an initial composition; and reacting the tall oil fatty acids with at least a portion of the neutralizing agent to produce a cleaning composition comprising a neutralized tall oil fatty acids, the solvent, and the water, wherein the cleaning composition comprises: about 0.02 wt % to about 26 wt % of the neutralized tall oil fatty acids; about 0.01 wt % to about 9 wt % of the solvent; and about 65 wt % to about 99.97 wt % of water, wherein all weight percent values are based on a combined weight of the neutralized tall oil fatty acids, the solvent, and the water.

11. The cleaning composition, the pre-moistened wipe, or the process according to any one of claims 1 to 10, wherein the cleaning composition is an emulsion and has a pH of about 1 to about 14 at a temperature of about 25° C.

12. The cleaning composition, the pre-moistened wipe, or the process according to any one of claims 1 to 10, wherein the cleaning composition is an aqueous solution and has a pH of about 6 to about 14 at a temperature of about 25° C.

13. The cleaning composition, the pre-moistened wipe, or the process according to any one of claims 1 to 10, wherein the cleaning composition is an aqueous solution and has a pH of about 8 to about 14 at a temperature of about 25° C.

14. The cleaning composition, the pre-moistened wipe, or the process according to any one of claims 1 to 3, 6 to 8, and 11 to 13, wherein the neutralized tall oil fatty acids is produced by reacting a tall oil fatty acids and a neutralizing agent.

15. The cleaning composition, the pre-moistened wipe, or the process according to any one of claims 4, 5, 9, 10, and 14, wherein the neutralizing agent comprises ammonium hydroxide, sodium hydroxide, potassium hydroxide, methylamine, ethylamine, triethylamine, n-propylamine, isopropylamine, n-butylamine, isobutylamine, sec-butylamine, t-butylamine, n-hexylamine, cyclohexyl amine, n-ocylamine, n-decylamine, n-dodecylamine, diisopropylamine, diisobutylamine, dicyclohexylamine, bis(2-ethylhexyl)amine, didecylamine, N,N-dimethyl-N′ ethylethlenediamine, pyrrolidine, piperidine, hexametheneimine, 2-pyrrolidinemethanol, heputamethyleneimine, 2-pyrrolidinie, piperazine, an alkanolamine, a glycolamine, or a mixture thereof.

16. The cleaning composition, the pre-moistened wipe, or the process of claim 15, wherein the neutralizing agent comprises the alkanolamine, and wherein the alkanolamine comprises monoethanolamine, diethanolamine, triethanolamine, isopropanolamine, diisopropanolamine, isobutanolamine, aminomethyl propanol, or a mixture thereof.

17. The cleaning composition, the pre-moistened wipe, or the process of claim 15, wherein the neutralizing agent comprises the glycolamine, and wherein the glycolamine comprises diethylene glycolamine, triethylene glycol amine, or a mixture thereof.

18. The cleaning composition, the pre-moistened wipe, or the process according to any one of claims 4, 5, 9, 10, and 14 to 16, wherein the tall oil fatty acids further comprises rosin acids, and wherein the tall oil fatty acids comprises less than 7 wt % of the rosin acids, based on a total weight of the tall oil fatty acids.

19. The cleaning composition, the pre-moistened wipe, or the process according to any one of claims 4, 5, 9, 10, and 14 to 16, wherein the tall oil fatty acids further comprises rosin acids, and wherein the tall oil fatty acids comprises up to 6 wt % of the rosin acids, based on a total weight of the tall oil fatty acids.

20. The cleaning composition, the pre-moistened wipe, or the process according to any one of claims 4, 5, 9, 10 and 14 to 16, wherein the tall oil fatty acids further comprises rosin acids, and wherein the tall oil fatty acids comprises less than 4 wt % of the rosin acids, based on a total weight of the tall oil fatty acids.

21. The cleaning composition, the pre-moistened wipe, or the process according to any one of claims 4, 5, 9, 10, and 14 to 16, wherein the tall oil fatty acids further comprises rosin acids, and wherein the tall oil fatty acids comprises less than 2 wt % of the rosin acids, based on a total weight of the tall oil fatty acids.

22. The cleaning composition, the pre-moistened wipe, or the process according to any one of claims 4, 5, 9, 10, and 14 to 16, wherein the tall oil fatty acids further comprises rosin acids, and wherein the tall oil fatty acids comprises up to 1.5 wt % of the rosin acids, based on a total weight of the tall oil fatty acids.

23. The cleaning composition, the pre-moistened wipe, or the process according to any one of claims 4, 5, and 9 to 22, wherein the tall oil fatty acids comprises mono-unsaturated fatty acids and di-unsaturated fatty acids.

24. The cleaning composition, the pre-moistened wipe, or the process according to any one of claims 4, 5, and 9 to 22, wherein the tall oil fatty acids comprises mono-unsaturated fatty acids and di-unsaturated fatty acids at a weight ratio of about 1.1:1 to about 1.5:1.

25. The cleaning composition, the pre-moistened wipe, or the process according to any one of claims 4, 5, and 9 to 22, wherein the tall oil fatty acids comprises di-unsaturated fatty acids and mono-unsaturated fatty acids at a weight ratio of about 1.1:1 to about 1.5:1.

26. The cleaning composition, the pre-moistened wipe, or the process according to any one of claims 4, 5, and 9 to 22, wherein the tall oil fatty acids comprises about 35 wt % to about 55 wt % of oleic acid, about 30 wt % to about 40 wt % of linoleic acid, and about 1 wt % to about 5 wt % of stearic acid, based on a total weight of the tall oil fatty acids.

27. The cleaning composition, the pre-moistened wipe, or the process according to any one of claims 4, 5, and 9 to 26, wherein the tall oil fatty acids has a minimum acid value of 190.

28. The cleaning composition, the pre-moistened wipe, or the process according to any one of claims 4, 5, and 9 to 26, wherein the tall oil fatty acids has a minimum acid value of 193.

29. The cleaning composition, the pre-moistened wipe, or the process according to any one of claims 4, 5, and 9 to 26, wherein the tall oil fatty acids has a minimum acid value of 195.

30. The cleaning composition, the pre-moistened wipe, or the process according to any one of claims 4, 5, and 9 to 26, wherein the tall oil fatty acids has a minimum acid value of 200.

31. The cleaning composition, the pre-moistened wipe, or the process according to any one of claims 1 to 30, wherein the solvent comprises an alcohol, a ketone, a glycol, an ether, a dibasic ester, a glycol ether, or a mixture thereof.

32. The cleaning composition, the pre-moistened wipe, or the process according to any one of claims 1 to 30, wherein the solvent comprises a glycol ether.

33. The cleaning composition, the pre-moistened wipe, or the process according to any one of claims 1 to 30, wherein the solvent comprises propylene glycol n-butyl ether.

34. The cleaning composition, the pre-moistened wipe, or the process according to any one of claims 1 to 33, wherein the water comprises distilled water, deionized water, reverse osmosis water, natural mineral water, spring water, or a mixture thereof.

35. The cleaning composition, the pre-moistened wipe, or the process according to any one of claims 1 to 33, wherein the water comprises distilled water, deionized water, or a mixture thereof.

36. The cleaning composition, the pre-moistened wipe, or the process according to any one of claims 1 to 35, wherein the cleaning composition comprises about 0.05 wt % to about 1 wt % of the neutralized tall oil fatty acids, about 0.05 wt % to about 3 wt % of the solvent, and about 96 wt % to about 99.9 wt % of water, based on a combined weight of the neutralized tall oil fatty acids, the solvent, and the water.

37. The cleaning composition, the pre-moistened wipe, or the process according to any one of claims 1 to 35, wherein the cleaning composition comprises about 0.1 wt % to about 0.4 wt % of the neutralized tall oil fatty acids, about 0.05 wt % to about 1.5 wt % of the solvent, and about 98.1 wt % to about 99.85 wt % of water, based on a combined weight of the neutralized tall oil fatty acids, the solvent, and the water.

38. The cleaning composition, the pre-moistened wipe, or the process according to any one of claims 1 to 37, wherein the cleaning composition further comprises a base compound.

39. The cleaning composition, the pre-moistened wipe, or the process according to any one of claims 1 to 37, wherein the cleaning composition further comprises a base compound, and wherein the base compound comprises ammonium hydroxide, sodium hydroxide, potassium hydroxide, methylamine, ethylamine, triethylamine, n-propylamine, isopropylamine, n-butylamine, isobutylamine, sec-butylamine, t-butylamine, n-hexylamine, cyclohexyl amine, n-ocylamine, n-decylamine, n-dodecylamine, diisopropylamine, diisobutylamine, dicyclohexylamine, bis(2-ethylhexyl)amine, didecylamine, N,N-dimethyl-N′ethylethlenediamine, pyrrolidine, piperidine, hexametheneimine, 2-pyrrolidinemethanol, heputamethyleneimine, 2-pyrrolidinie, piperazine, an alkanolamine, a glycolamine, or a mixture thereof.

40. The cleaning composition, the pre-moistened wipe, or the process of claim 39, wherein the base compound comprises the alkanolamine, and wherein the alkanolamine comprises monoethanolamine, diethanolamine, triethanolamine, isopropanolamine, diisopropanolamine, isobutanolamine, aminomethyl propanol, or a mixture thereof.

41. The cleaning composition, the pre-moistened wipe, or the process of claim 39, wherein the base compound comprises the glycolamine, and wherein the glycolamine comprises diethylene glycolamine, triethylene glycol amine, or a mixture thereof.

42. The cleaning composition, the pre-moistened wipe, or the process according to any one of claims 38 to 41, wherein the cleaning composition comprises about 0.001 wt % to about 10.5 wt % of the base compound, based on the combined weight of the neutralized tall oil fatty acids, the solvent, and the water.

43. The cleaning composition, the pre-moistened wipe, or the process according to any one of claims 38 to 41, wherein the cleaning composition comprises about 0.001 wt % to about 5 wt % of the base compound, based on the combined weight of the neutralized tall oil fatty acids, the solvent, and the water.

44. The cleaning composition, the pre-moistened wipe, or the process according to any one of claims 1 to 43, wherein the cleaning composition further comprises a fragrance.

45. The cleaning composition, the pre-moistened wipe, or the process of claim 44, wherein the cleaning composition comprises about 0.001 wt % to about 5.1 wt % of the fragrance, based on the combined weight of the neutralized tall oil fatty acids, the solvent, and the water.

46. The cleaning composition, the pre-moistened wipe, or the process of claim 44, wherein the cleaning composition comprises about 0.001 wt % to about 1 wt % of the fragrance, based on the combined weight of the neutralized tall oil fatty acids, the solvent, and the water.

47. The cleaning composition, the pre-moistened wipe, or the process according to any one of claims 1 to 46, wherein the cleaning composition further comprises a non-ionic surfactant.

48. The cleaning composition, the pre-moistened wipe, or the process according to any one of claims 1 to 46, wherein the cleaning composition further comprises a non-ionic surfactant, and wherein the non-ionic surfactant comprises an alcohol ethoxylate, an alkyl polyglucoside, a nonylphenol ethoxylate, an octyphenol ethoxylate, an ethoxylated and propoxylated compound, or any mixture thereof.

49. The cleaning composition, the pre-moistened wipe, or the process according to any one of claims 1 to 46, wherein the cleaning composition further comprises a non-ionic surfactant, and wherein the non-ionic surfactant comprises a decyl/undecyl glucoside.

50. The cleaning composition, the pre-moistened wipe, or the process according to any one of claims 47 to 49, wherein the cleaning composition comprises about 0.01 wt % to about 30.5 wt % of the non-ionic surfactant, based on the combined weight of the neutralized tall oil fatty acids, the solvent, and the water.

51. The cleaning composition, the pre-moistened wipe, or the process according to any one of claims 47 to 49, wherein the cleaning composition comprises about 0.01 wt % to about 5 wt % of the non-ionic surfactant, based on the combined weight of the neutralized tall oil fatty acids, the solvent, and the water.

52. The cleaning composition, the pre-moistened wipe, or the process according to any one of claims 1 to 51, wherein the cleaning composition further comprises a preservative.

53. The cleaning composition, the pre-moistened wipe, or the process according to any one of claims 1 to 51, wherein the cleaning composition further comprises a preservative, and wherein the preservative comprises methylisothiazolinone, benzoisothiazolinone, methylchloroisothiazolinone, octylisothiazolinone, phenoxyethanol, caprylyl glycol, a paraben, a sodium salt of a paraben, butylated hydroxytoluene, dehydroacetic acid, benzoic acid, sodium benzoate, a quaternary ammonium salt, imidazolindinyl urea, diazolindnyl urea, DMDM hydantoin, 2-bromo-2-nitropropane-1,3-diol, 5-bromo-5-nitro-1,3-dioxane, tris(hydroxymethyl nitromethane, or a mixture thereof.

54. The cleaning composition, the pre-moistened wipe, or the process according to any one of claims 1 to 51, wherein the cleaning composition further comprises a preservative, and wherein the preservative comprises a mixture of 2-methyl-4-isothiazolin-3-one and 2-n-Octyl-4-isothiazolin-3 -one.

55. The cleaning composition, the pre-moistened wipe, or the process according to any one of claims 1 to 51, wherein the cleaning composition further comprises a preservative, and wherein the preservative comprises a mixture of phenoxyethanol and caprylyl glycol.

56. The cleaning composition, the pre-moistened wipe, or the process according to any one of claims 52 to 55, wherein the cleaning composition comprises about 0.001 wt % to about 2.1 wt % of the preservative, based on the combined weight of the neutralized tall oil fatty acids, the solvent, and the water.

57. The cleaning composition, the pre-moistened wipe, or the process according to any one of claims 52 to 55, wherein the cleaning composition comprises about 0.001 wt % to about 1 wt % of the preservative, based on the combined weight of the neutralized tall oil fatty acids, the solvent, and the water.

58. The cleaning composition, the pre-moistened wipe, or the process according to any one of claims 52 to 55, wherein the cleaning composition comprises about 0.001 wt % to about 0.7 wt % of the preservative, based on the combined weight of the neutralized tall oil fatty acids, the solvent, and the water.

59. The cleaning composition, the pre-moistened wipe, or the process according to any one of claims 1 to 58, wherein the cleaning composition further comprises a corrosion inhibitor.

60. The cleaning composition, the pre-moistened wipe, or the process according to any one of claims 1 to 58, wherein the cleaning composition further comprises a corrosion inhibitor, and wherein the corrosion inhibitor comprises sodium mercaptobenzothiazole, polyether phosphate, benzotriazole, or a mixture thereof.

61. The cleaning composition, the pre-moistened wipe, or the process according to claim 59 or 60, wherein the cleaning composition comprises about 0.001 wt % to about 7.5 wt % of the corrosion inhibitor, based on the combined weight of the neutralized tall oil fatty acids, the solvent, and the water.

62. The cleaning composition, the pre-moistened wipe, or the process according to claim 59 or 60, wherein the cleaning composition comprises about 0.001 wt % to about 3 wt % of the corrosion inhibitor, based on the combined weight of the neutralized tall oil fatty acids, the solvent, and the water.

63. The cleaning composition, the pre-moistened wipe, or the process according to any one of paragraphs 1 to 62, wherein the cleaning composition further comprises a viscosity modifier.

64. The cleaning composition, the pre-moistened wipe, or the process according to paragraph 63, wherein the viscosity modifier comprises one or more carbomers, one or more laponites, one or more illites, one or more smectites, one or more micas, or any mixture thereof.

65. The pre-moistened wipe according to any one of paragraphs 2, 7, and 11 to 64, wherein the substrate comprises a non-woven substrate.

66. The pre-moistened wipe according to paragraph 65, wherein the non-woven substrate comprises a plurality of bast fibers and a plurality of polyactic acid fibers.

67. The pre-moistened wipe according to paragraph 66, wherein the plurality of bast fibers is thermally bonded with the plurality of polyactic acid fibers.

68. The pre-moistened wipe according to paragraph 65, wherein the non-woven substrate comprises a plurality of fibers, and wherein the plurality of fibers comprises polyester fibers, nylon fibers, polyethylene fibers, polypropylene fibers, cotton fibers, wool fibers, silk fibers, wood pulp fibers, e.g., cellulose fibers, bast fibers, e.g., fibers found in the stalks of the flax, hemp, jute, ramie, nettle, Spanish broom, and/or kenaf plants, or any mixture thereof.

69. The pre-moistened wipe according to paragraph 65, wherein the non-woven substrate comprises a plurality of biodegradable fibers.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A cleaning composition, comprising:
about 0.02 wt % to about 26 wt % of a neutralized tall oil fatty acids;
about 0.01 wt % to about 9 wt % of a solvent; and
about 65 wt % to about 99.97 wt % of water, wherein all weight percent values are based on a combined weight of the neutralized tall oil fatty acids, the solvent, and the water.

2. The cleaning composition of claim 1, wherein the cleaning composition comprises about 0.02 wt % to about 26 wt % of the neutralized tall oil fatty acids; about 0.01 wt % to about 5 wt % of the solvent; and about 69 wt % to about 99.97 wt % of the water, based on a combined weight of the neutralized tall oil fatty acids, the solvent, and the water.

3. The cleaning composition of claim 1, wherein the cleaning composition is an emulsion or an aqueous solution and has a pH of about 6 to about 14 at a temperature of about 25° C.

4. The cleaning composition of claim 1, wherein the neutralized tall oil fatty acids is produced by reacting a tall oil fatty acids and a neutralizing agent, and wherein the neutralizing agent comprises ammonium hydroxide, sodium hydroxide, potassium hydroxide, methylamine, ethylamine, triethylamine, n-propylamine, isopropylamine, n-butylamine, isobutylamine, sec-butylamine, t-butylamine, n-hexylamine, cyclohexyl amine, n-ocylamine, n-decylamine, n-dodecylamine, diisopropylamine, diisobutylamine, dicyclohexylamine, bis(2-ethylhexyl)amine, didecylamine, N,N-dimethyl-N′ethylethlenediamine, pyrrolidine, piperidine, hexametheneimine, 2-pyrrolidinemethanol, heputamethyleneimine, 2-pyrrolidinie, piperazine, an alkanolamine, a glycolamine, or a mixture thereof.

5. The cleaning composition of claim 4, wherein the tall oil fatty acids further comprises rosin acids, and wherein the tall oil fatty acids comprises less than 7 wt % of the rosin acids, based on a total weight of the tall oil fatty acids.

6. The cleaning composition of claim 4, wherein the tall oil fatty acids comprises about 35 wt % to about 55 wt % of oleic acid, about 30 wt % to about 40 wt % of linoleic acid, and about 1 wt % to about 5 wt % of stearic acid, based on a total weight of the tall oil fatty acids.

7. The cleaning composition of claim 4, wherein the tall oil fatty acids has a minimum acid value of 190.

8. The cleaning composition of claim 1, wherein the solvent comprises an alcohol, a ketone, a glycol, an ether, a dibasic ester, a glycol ether, or a mixture thereof.

9. The cleaning composition of claim 1, wherein the cleaning composition comprises about 0.05 wt % to about 1 wt % of the neutralized tall oil fatty acids, about 0.05 wt % to about 3 wt % of the solvent, and about 96 wt % to about 99.9 wt % of water, based on a combined weight of the neutralized tall oil fatty acids, the solvent, and the water.

10. The cleaning composition of claim 1, further comprising about 0.001 wt % to about 10.5 wt % of a base compound, based on the combined weight of the neutralized tall oil fatty acids, the solvent, and the water.

11. The cleaning composition of claim 1, further comprising about 0.01 wt % to about 30.5 wt % of a non-ionic surfactant, based on the combined weight of the neutralized tall oil fatty acids, the solvent, and the water.

12. The cleaning composition of claim 1, further comprising about 0.001 wt % to about 2.1 wt % of a preservative, based on the combined weight of the neutralized tall oil fatty acids, the solvent, and the water.

13. The cleaning composition of claim 1, further comprising about 0.01 wt % to about 2 wt % of a chelating agent, based on the combined weight of the neutralized tall oil fatty acids, the solvent, and the water.

14. The cleaning composition of claim 1, further comprising about 0.001 wt % to about 5.1 wt % of a fragrance, based on the combined weight of the neutralized tall oil fatty acids, the solvent, and the water.

15. The cleaning composition of claim 1, further comprising about 0.001 wt % to about 7.5 wt % of a corrosion inhibitor, based on the combined weight of the neutralized tall oil fatty acids, the solvent, and the water.

16. The cleaning composition of claim 1, further comprising about 0.001 wt % to about 10.5 wt % of a base compound, about 0.01 wt % to about 30.5 wt % of a non-ionic surfactant, and about 0.001 wt % to about 2.1 wt % of a preservative, based on the combined weight of the neutralized tall oil fatty acids, the solvent, and the water.

17. The cleaning composition of claim 16, wherein:
the solvent comprises an alcohol, a ketone, a glycol, an ether, a dibasic ester, a glycol ether, or a mixture thereof,
the water comprises distilled water, deionized water, reverse osmosis water, natural mineral water, spring water, or a mixture thereof,
the base compound comprises ammonium hydroxide, sodium hydroxide, potassium hydroxide, methylamine, ethylamine, triethylamine, n-propylamine, isopropylamine, n-butylamine, isobutylamine, sec-butylamine, t-butylamine, n-hexylamine, cyclohexylamine, n-ocylamine, n-decylamine, n-dodecylamine, diisopropylamine, diisobutylamine, dicyclohexylamine, bis(2-ethylhexyl)amine, didecylamine, N,N-dimethyl-N′ethylethlenediamine, pyrrolidine, piperidine, hexametheneimine, 2-pyrrolidinemethanol, heputamethyleneimine, 2-pyrrolidinie, piperazine, an alkanolamine, a glycolamine, or a mixture thereof,
the non-ionic surfactant comprises an alcohol ethoxylate, an alkyl polyglucoside, a nonylphenol ethoxylate, an octyphenol ethoxylate, an ethoxylated and propoxylated compound, or any mixture thereof, and
the preservative comprises methylisothiazolinone, benzoisothiazolinone, methylchloroisothiazolinone, octylisothiazolinone, phenoxyethanol, caprylyl glycol, a paraben, a sodium salt of a paraben, butylated hydroxytoluene, dehydroacetic acid, benzoic acid, sodium benzoate, a quaternary ammonium salt, imidazolindinyl urea, diazolindnyl urea, DMDM hydantoin, 2-bromo-2-nitropropane-1,3-diol, 5-bromo-5-nitro-1,3-dioxane, tris(hydroxymethyl nitromethane, or a mixture thereof.

18. The cleaning composition of claim 1, wherein:
the neutralized tall oil fatty acids is produced by reacting a neutralizing agent and a tall oil fatty acids comprising a mixture of fatty acids and rosin acids,
the tall oil fatty acids comprises about 35 wt % to about 55 wt % of oleic acid, about 30 wt % to about 40 wt % of linoleic acid, about 1 wt % to about 5 wt % of stearic acid, and less than 7 wt % of the rosin acids, based on a total weight of the tall oil fatty acids, and
the neutralizing agent comprises ammonium hydroxide, sodium hydroxide, potassium hydroxide, methylamine, ethylamine, triethylamine, n-propylamine, isopropylamine, n-butylamine, isobutylamine, sec-butylamine, t-butylamine, n-hexylamine, cyclohexyl amine, n-ocylamine, n-decylamine, n-dodecylamine, diisopropylamine, diisobutylamine, dicyclohexylamine, bis(2-ethylhexyl)amine, didecylamine, N,N-dimethyl-N′ethylethlenediamine, pyrrolidine, piperidine, hexametheneimine, 2-pyrrolidinemethanol, heputamethyleneimine, 2-pyrrolidinie, piperazine, an alkanolamine, a glycolamine, or a mixture thereof.

19. A pre-moistened wipe for cleaning a surface, comprising:
a substrate; and
a cleaning composition, wherein the cleaning composition comprises:
about 0.02 wt % to about 26 wt % of a neutralized tall oil fatty acids;
about 0.01 wt % to about 9 wt % of a solvent; and
about 65 wt % to about 99.97 wt % of water, wherein all weight percent values are based on a combined weight of the neutralized tall oil fatty acids, the solvent, and the water.

20. A process for making a cleaning composition, comprising:
reacting a tall oil fatty acids with at least a portion of a neutralizing agent to produce a neutralized tall oil fatty acids;
combining the neutralized tall oil fatty acids, a solvent, and water to produce the cleaning composition, wherein the cleaning composition comprises:
about 0.02 wt % to about 26 wt % of the neutralized tall oil fatty acids;
about 0.01 wt % to about 9 wt % of the solvent; and
about 65 wt % to about 99.97 wt % of water, wherein all weight percent values are based on a combined weight of the neutralized tall oil fatty acids, the solvent, and the water.
